(19) United States
(12) Patent Application Publication
(10) Pub. No.: US 2019/0044812 A1
(43) Pub. Date: Feb. 7, 2019

(54) TECHNOLOGIES FOR DYNAMICALLY SELECTING RESOURCES FOR VIRTUAL SWITCHING

(71) Applicant: Intel Corporation, Santa Clara, CA (US)

(72) Inventors: Ciara Loftus, Galway (IE); Chris MacNamara, Limerick (IE); John J. Browne, Limerick (IE); Patrick Fleming, Slatt Wolfhill (IE); Tomasz Kantecki, Ennis (IE); John Barry, Galway (IE); Patrick Connor, Beaverton, OR (US)

(21) Appl. No.: 16/131,009

(22) Filed: Sep. 13, 2018

(51) Int. Cl. H04L 12/24; H04L 12/923; H04L 12/911; H04L 12/931; G06F 11/34

(52) U.S. Cl. CPC H04L 41/0896; H04L 47/762; H04L 47/822; G06F 11/3442; H04L 41/5019; H04L 49/70; H04L 41/0816

(57) ABSTRACT

Technologies for dynamically selecting resources for virtual switching include a network appliance configured to identify a present demand on processing resources of the network appliance that are configured to process data associated with network packets received by the network appliance. Additionally, the network appliance is configured to determine a present capacity of one or more acceleration resources of the network appliance and determine a virtual switch operation mode based on the present demand and the present capacity of the acceleration resources, wherein the virtual switch operation mode indicates which of the acceleration resources are to be enabled. The network appliance is additionally configured to configure a virtual switch of the network appliance to operate as a function of the determined virtual switch operation mode and assign acceleration resources of the network appliance as a function of the determined virtual switch operation mode. Other embodiments are described herein.

### BACKGROUND

Modern computing devices have become ubiquitous tools for personal, business, and social uses. As such, many modern computing devices are capable of connecting to various data networks, including the Internet, to transmit and receive data communications over the various data networks at varying rates of speed. To facilitate communications between computing devices, the data networks typically include one or more network computing devices (e.g., compute servers, storage servers, etc.) to route communications (e.g., via switches, routers, etc.) that enter/exit a network (e.g., north-south network traffic) and between network computing devices in the network (e.g., east-west network traffic). Such data networks typically have included complex, large-scale computing environments, such as high-performance computing (HPC) and cloud computing environments. Traditionally, those data networks have included dedicated hardware devices, commonly referred to as network appliances, configured to perform a single function, such as security (e.g., a firewall, authentication, etc.), network address translation (NAT), load-balancing, deep packet inspection (DPI), transmission control protocol (TCP) optimization, caching, Internet Protocol (IP) management, etc.

More recently, network operators and service providers are relying on various network virtualization technologies (e.g., network function virtualization (NFV)) to provide network functions as virtual services which can be executed by a virtualization platform (e.g., using virtual machines (VMs) executing virtualized network functions) on general purpose hardware. To effectuate such network virtualization technologies, virtual switches are often employed (e.g., embedded into virtualization software or in a computing device's hardware as part of its firmware) to allow the VMs to communicate with each other, by intelligently directing communication on the network, such as by inspecting packets before passing them on. Present virtual switching technologies may be manually configured and statically allocated based on predicted or worst-case bandwidth for several use cases. However, such static configuration (e.g., by a user/operator or management layer) can result in significant drawbacks, including packet loss (e.g., at time of high network load), the computing device is never “cloud-ready” as its operations are typically not hardware agnostic, performance/power usage is oftentimes poor (e.g., at times of low network load), resources can only be provisioned to a fixed maximum capacity (e.g., based on the statically assigned resources) making scaling difficult, etc.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for dynamically selecting resources for virtual switching that includes a source compute device communicatively coupled to a network appliance;

FIG. 2 is a simplified block diagram of at least one embodiment of an environment of the network appliance of the system of FIG. 1;

FIGS. 3A and 3B are a simplified block diagram of at least one embodiment of a method for dynamically selecting resources for virtual switching that may be executed by the network appliance of FIGS. 1 and 2;

FIG. 4 is a simplified block diagram of at least one other embodiment of an environment of the network appliance of FIGS. 1 and 2; and

FIG. 5 is a simplified illustration of at least one embodiment of a table that illustrates the network appliance of FIGS. 1 and 2 having dynamically selected resources for virtual switching over an elapsed amount of time.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one of A, B, and C” can mean (A); (B); (C): (A and B); (A and C); (B and C); or (A, B, and C). Similarly, items listed in the form of “at least one of A, B, or C” can mean (A); (B); (C): (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

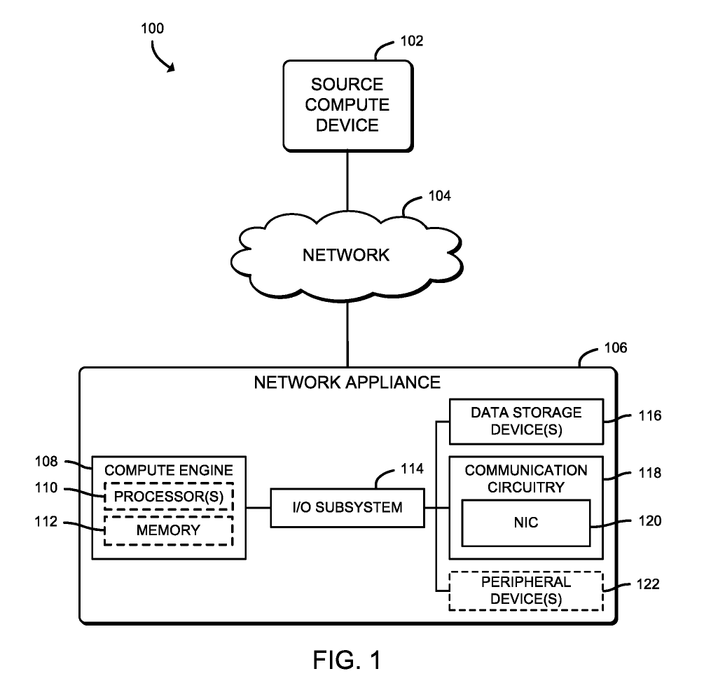

Referring now to FIG. 1, in an illustrative embodiment, a system 100 for dynamically selecting resources for virtual switching includes a source compute device 102 communicatively coupled to a network appliance 106 via a network 104. It should be appreciated that while only a single network appliance 106 is shown, the system 100 may include multiple network appliances 106, in other embodiments. It should be further appreciated that the source compute device 102 and the network appliance 106 may reside in the same data center or high-performance computing (HPC) environment. Additionally or alternatively, the source compute device 102 and the network appliance 106 may reside in the same network 104 connected via one or more wired and/or wireless interconnects.

The network appliance 106 is configured to receive network packets (e.g., Ethernet frames, messages, etc.), such as may be received from the source compute devices 102 via the network 104, perform some level of processing (e.g., one or more processing operations) on at least a portion of the data associated with the received network packets, and either drop or transmit each received network packet to a destination (e.g., to another network appliance in the same or alternative network, based to the source compute device 102, etc.). To perform the processing operations, the network appliance 106 may be configured to leverage virtualization technologies to provide one or more virtualized network functions (VNFs) (e.g., executing on one or more virtual machines (VMs), in one or more containers, etc.) to execute network services on commodity hardware. Such network services may include any type of network service, including firewall services, network address translation (NAT) services, domain name system (DNS) services, load-balancing services, deep packet inspection (DPI) services, transmission control protocol (TCP) optimization services, cache management services, Internet Protocol (IP) address management services, etc.

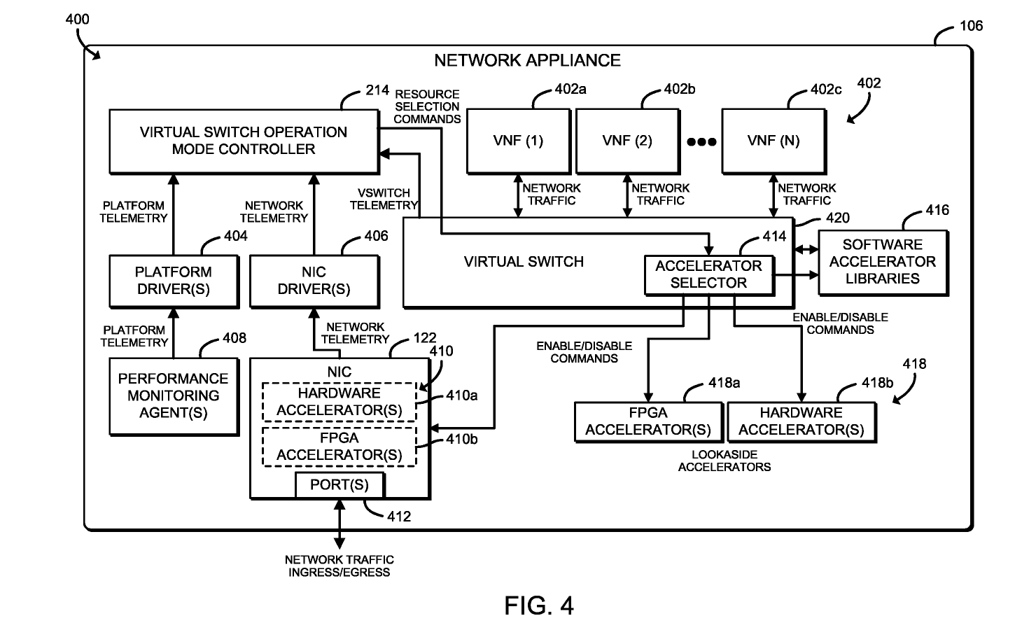

In network function virtualization (NFV) architecture, a VNF is configured to handle specific network functions that run in one or more VMs on top of hardware networking infrastructure traditionally carried out by proprietary, dedicated hardware, such as routers, switches, servers, cloud computing systems, etc. In other words, each VNF may be embodied as one or more VMs configured to execute corresponding software or instructions to perform a virtualized task. It should be understood that a VM is a software program or operating system that not only exhibits the behavior of a separate computer, but is also capable of performing tasks such as running applications and programs like a separate computer. A VM, commonly referred to as a “guest,” is typically configured to run a dedicated operating system on shared physical hardware resources of the device on which the VM has been deployed, commonly referred to as a “host.” It should be appreciated that multiple VMs can exist within a single host at a given time and that multiple VNFs (see, e.g., the illustrative VNFs 402 of FIG. 4) may be executing on the network appliance 106 at a time.

In use, as will be described in further detail below, the network appliance 106 switches on/off accelerations and offloads as required (i.e., dynamically). To do so, the network appliance 106 identifies a demand associated with network traffic and/or an application (e.g., one or more of the connected VNFs) executing on the network appliance 106, and automatically selects different sets of resources (e.g., based on a characteristic of the demand, such as power, compute, storage, etc.) to provide the virtual switching function depending on the identified demand. Accordingly, the network appliance 106 can provide improved performance (e.g., per watt) for virtual switching by only switching on additional accelerations and offloads when required, which can be based on time of day, a current networking load, a predicated networking load demand, etc.

Depending on the embodiment, the network appliance 106 may be configured to offload various functions/operations to accelerators, including, without limitation, packet processing, Network address translation (NAT), filtering, routing, forwarding, encryption, decryption, encapsulation, decapsulation, tunneling, packet parsing, APR responses, packet verification, packet integrity validation, authentication, checksum calculation, checksum verification, packet reordering, DDOS detection, DDOS mitigation, access control, connection setup, connection teardown, TCP termination, header splitting, packet duplication detection, removal of packet duplication, forwarding table updates, statistics generation, stats collection, telemetry generation, telemetry collection, telemetry transmission, Simple Network Management Protocol (SNMP), NUMA node determination, Core determination, VM/container determination, hairpin determination, hairpin switching.

The network appliance 106 may be embodied as any type of computation or computing device capable of performing the functions described herein, including, without limitation, a server (e.g., stand-alone, rack-mounted, blade, etc.), a switch (e.g., a disaggregated switch, a rack-mounted switch, a standalone switch, a fully managed switch, a partially managed switch, a full-duplex switch, and/or a half-duplex communication mode enabled switch), a sled (e.g., a compute sled, a storage sled, an accelerator sled, a memory sled, etc.) a router, a web appliance, a processor-based system, and/or a multiprocessor system. Depending on the embodiment, the network appliance 106 may be embodied as a distributed computing system. In such embodiments, the network appliance 106 may be embodied as more than one computing device in which each computing device is configured to pool resources and perform at least a portion of the functions described herein.

As shown in FIG. 1, the illustrative network appliance 106 includes a compute engine 108, an I/O subsystem 114, one or more data storage devices 116, communication circuitry 118, and, in some embodiments, one or more peripheral devices 122. It should be appreciated that the network appliance 106 may include other or additional components, such as those commonly found in a typical computing device (e.g., various input/output devices and/or other components), in other embodiments. Additionally, in some embodiments, one or more of the illustrative components may be incorporated in, or otherwise form a portion of, another component.

The compute engine 108 may be embodied as any type of device or collection of devices capable of performing the various compute functions as described herein. In some embodiments, the compute engine 108 may be embodied as a single device such as an integrated circuit, an embedded system, a field-programmable-array (FPGA), a system-on-a-chip (SOC), an application specific integrated circuit (ASIC), reconfigurable hardware or hardware circuitry, or other specialized hardware to facilitate performance of the functions described herein. Additionally, in some embodiments, the compute engine 108 may include, or may otherwise be embodied as, one or more processors 110 (i.e., one or more central processing units (CPUs)) and memory 112.

The processor(s) 110 may be embodied as any type of processor(s) capable of performing the functions described herein. For example, the processor(s) 110 may be embodied as one or more single-core processors, multi-core processors, digital signal processors (DSPs), microcontrollers, or other processor(s) or processing/controlling circuit(s). In some embodiments, the processor(s) 110 may be embodied as, include, or otherwise be coupled to an FPGA (e.g., reconfigurable circuitry), an ASIC, reconfigurable hardware or hardware circuitry, or other specialized hardware to facilitate performance of the functions described herein.

The memory 112 may be embodied as any type of volatile or non-volatile memory or data storage capable of performing the functions described herein. It should be appreciated that the memory 112 may include main memory (i.e., a primary memory) and/or cache memory (i.e., memory that can be accessed more quickly than the main memory). Volatile memory may be a storage medium that requires power to maintain the state of data stored by the medium. Non-limiting examples of volatile memory may include various types of random access memory (RAM), such as dynamic random access memory (DRAM) or static random access memory (SRAM).

The compute engine 108 is communicatively coupled to other components of the network appliance 106 via the I/O subsystem 114, which may be embodied as circuitry and/or components to facilitate input/output operations with the processor 110, the memory 112, and other components of the network appliance 106. For example, the I/O subsystem 114 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 114 may form a portion of a SoC and be incorporated, along with one or more of the processor 110, the memory 112, and other components of the network appliance 106, on a single integrated circuit chip.

The one or more data storage devices 116 may be embodied as any type of storage device(s) configured for short-term or long-term storage of data, such as, for example, memory devices and circuits, memory cards, hard disk drives, solid-state drives, or other data storage devices. Each data storage device 116 may include a system partition that stores data and firmware code for the data storage device 116. Each data storage device 116 may also include an operating system partition that stores data files and executables for an operating system.

The communication circuitry 118 may be embodied as any communication circuit, device, or collection thereof, capable of enabling communications between the network appliance 106 and other computing devices, such as the source compute device 102, as well as any network communication enabling devices, such as an access point, network switch/router, etc., to allow communication over the network 104. Accordingly, the communication circuitry 118 may be configured to use any one or more communication technologies (e.g., wireless or wired communication technologies) and associated protocols (e.g., Ethernet, Bluetooth®, WiFi®, WiMAX, LTE, 5G, etc.) to effect such communication.

It should be appreciated that, in some embodiments, the communication circuitry 118 may include specialized circuitry, hardware, or combination thereof to perform pipeline logic (e.g., hardware algorithms) for performing the functions described herein, including processing network packets (e.g., parse received network packets, determine destination computing devices for each received network packets, forward the network packets to a particular buffer queue of a respective host buffer of the network appliance 106, etc.), performing computational functions, etc.

In some embodiments, performance of one or more of the functions of communication circuitry 118 as described herein may be performed by specialized circuitry, hardware, or combination thereof of the communication circuitry 118, which may be embodied as a SoC or otherwise form a portion of a SoC of the network appliance 106 (e.g., incorporated on a single integrated circuit chip along with a processor 110, the memory 112, and/or other components of the network appliance 106). Alternatively, in some embodiments, the specialized circuitry, hardware, or combination thereof may be embodied as one or more discrete processing units of the network appliance 106, each of which may be capable of performing one or more of the functions described herein.

The illustrative communication circuitry 118 includes the NIC 120, which may also be referred to as a host fabric interface (HFI) in some embodiments (e.g., high performance computing (HPC) environments). The NIC 120 may be embodied as any type of firmware, hardware, software, or any combination thereof that facilities communications access between the network appliance 106 and a network (e.g., the network 104). For example, the NIC 120 may be embodied as one or more add-in-boards, daughtercards, network interface cards, controller chips, chipsets, or other devices that may be used by the network appliance 106 to connect with another compute device (e.g., the source compute device 102).

In some embodiments, the NIC 120 may be embodied as part of a SoC that includes one or more processors, or included on a multichip package that also contains one or more processors. Additionally or alternatively, in some embodiments, the NIC 120 may include one or more processing cores (not shown) local to the NIC 120. In such embodiments, the processing core(s) may be capable of performing one or more of the functions described herein. In some embodiments, the NIC 120 may additionally include a local memory (not shown). In such embodiments, the local memory of the NIC 120 may be integrated into one or more components of the network appliance 106 at the board level, socket level, chip level, and/or other levels. While not illustratively shown, it should be appreciated that the NIC 120 typically includes one or more physical ports (e.g., for facilitating the ingress and egress of network traffic) and, in some embodiments, one or more accelerator (e.g., ASIC, FPGA, etc.) and/or offload hardware components for performing/offloading certain network functionality and/or processing functions (e.g., a DMA engine).

The one or more peripheral devices 122 may include any type of device that is usable to input information into the network appliance 106 and/or receive information from the network appliance 106. The peripheral devices 122 may be embodied as any auxiliary device usable to input information into the network appliance 106, such as a keyboard, a mouse, a microphone, a barcode reader, an image scanner, etc., or output information from the network appliance 106, such as a display, a speaker, graphics circuitry, a printer, a projector, etc. It should be appreciated that, in some embodiments, one or more of the peripheral devices 122 may function as both an input device and an output device (e.g., a touchscreen display, a digitizer on top of a display screen, etc.). It should be further appreciated that the types of peripheral devices 122 connected to the network appliance 106 may depend on, for example, the type and/or intended use of the network appliance 106. Additionally or alternatively, in some embodiments, the peripheral devices 122 may include one or more ports, such as a USB port, for example, for connecting external peripheral devices to the network appliance 106.

The source compute device 102 may be embodied as any type of computation or computer device capable of performing the functions described herein, including, without limitation, a smartphone, a mobile computing device, a tablet computer, a laptop computer, a notebook computer, a computer, a server (e.g., stand-alone, rack-mounted, blade, etc.), a sled (e.g., a compute sled, an accelerator sled, a storage sled, a memory sled, etc.), a network appliance (e.g., physical or virtual), a web appliance, a distributed computing system, a processor-based system, and/or a multiprocessor system. While not illustratively shown, it should be appreciated that source compute device 102 includes similar and/or like components to those of the illustrative network appliance 106. As such, figures and descriptions of the like/similar components are not repeated herein for clarity of the description with the understanding that the description of the corresponding components provided above in regard to the network appliance 106 applies equally to the corresponding components of the source compute device 102. Of course, it should be appreciated that the computing devices may include additional and/or alternative components, depending on the embodiment.

The network 104 may be embodied as any type of wired or wireless communication network, including but not limited to a wireless local area network (WLAN), a wireless personal area network (WPAN), an edge network (e.g., a multi-access edge computing (MEC) network), a fog network, a cellular network (e.g., Global System for Mobile Communications (GSM), Long-Term Evolution (LTE), 5G, etc.), a telephony network, a digital subscriber line (DSL) network, a cable network, a local area network (LAN), a wide area network (WAN), a global network (e.g., the Internet), or any combination thereof. It should be appreciated that, in such embodiments, the network 104 may serve as a centralized network and, in some embodiments, may be communicatively coupled to another network (e.g., the Internet). Accordingly, the network 104 may include a variety of other virtual and/or physical network computing devices (e.g., routers, switches, network hubs, servers, storage devices, compute devices, etc.), as needed to facilitate communication between the network appliance 106 and the source compute device 102, which are not shown to preserve clarity of the description.

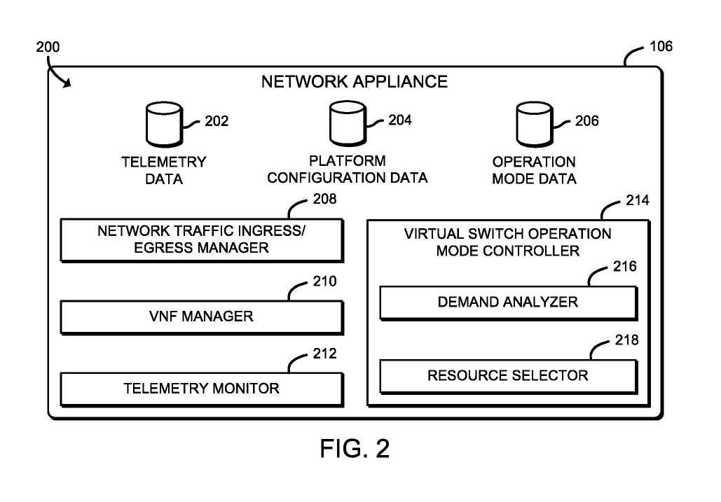

Referring now to FIG. 2, in use, the network appliance 106 establishes an environment 200 during operation. The illustrative environment 200 includes a network traffic ingress/egress manager 208, a VNF manager 210, a telemetry monitor 212, and a virtual switch operation mode controller 214. The various components of the environment 200 may be embodied as hardware, firmware, software, or a combination thereof. As such, in some embodiments, one or more of the components of the environment 200 may be embodied as circuitry or collection of electrical devices (e.g., network traffic ingress/egress management circuitry 208, VNF management circuitry 210, telemetry monitoring circuitry 212, virtual switch operation mode controlling circuitry 214, etc.). It should be appreciated that one or more functions described herein as being performed by the network traffic ingress/egress management circuitry 208, the VNF management circuitry 210, the telemetry monitoring circuitry 212, and/or the virtual switch operation mode controlling circuitry 214 may be performed, at least in part, by one or more other components of the network appliance 106, such as the compute engine 108, the I/O subsystem 114, the communication circuitry 118 (e.g., the NIC 120), an ASIC, a programmable circuit such as an FPGA, and/or other components of the network appliance 106. It should be further appreciated that associated instructions may be stored in the memory 112, the data storage device(s) 116, and/or other data storage location, which may be executed by one of the processors 110 and/or other computational processor of the network appliance 106.

Additionally, in some embodiments, one or more of the illustrative components may form a portion of another component and/or one or more of the illustrative components may be independent of one another. Further, in some embodiments, one or more of the components of the environment 200 may be embodied as virtualized hardware components or emulated architecture, which may be established and maintained by the NIC 120, the compute engine 108, and/or other software/hardware components of the network appliance 106. It should be appreciated that the network appliance 106 may include other components, sub-components, modules, sub-modules, logic, sub-logic, and/or devices commonly found in a computing device (e.g., device drivers, interfaces, etc.), which are not illustrated in FIG. 2 for clarity of the description.

In the illustrative environment 200, the network appliance 106 additionally includes telemetry data 202, platform configuration data 204, and operation mode data 206, each of which may be accessed by the various components and/or sub-components of the network appliance 106. Further, each of the telemetry data 202, the platform configuration data 204, and the operation mode data 206 may be accessed by the various components of the network appliance 106. Additionally, it should be appreciated that in some embodiments the data stored in, or otherwise represented by, each of the telemetry data 202, the platform configuration data 204, and the operation mode data 206 may not be mutually exclusive relative to each other. For example, in some implementations, data stored in the telemetry data 202 may also be stored as a portion of one or more of the platform configuration data 204 and/or the operation mode data 206, or in another alternative arrangement. As such, although the various data utilized by the network appliance 106 is described herein as particular discrete data, such data may be combined, aggregated, and/or otherwise form portions of a single or multiple data sets, including duplicative copies, in other embodiments.

The network traffic ingress/egress manager 208, which may be embodied as hardware, firmware, software, virtualized hardware, emulated architecture, and/or a combination thereof as discussed above, is configured to receive inbound and route/transmit outbound network traffic. To do so, the network traffic ingress/egress manager 208 is configured to facilitate inbound/outbound network communications (e.g., network traffic, network packets, network flows, etc.) to and from the network appliance 106. For example, the network traffic ingress/egress manager 208 is configured to manage (e.g., create, modify, delete, etc.) connections to physical and virtual network ports (i.e., virtual network interfaces) of the network appliance 106 (e.g., via the communication circuitry 118), as well as the ingress/egress buffers/queues associated therewith.

The VNF manager 210, which may be embodied as hardware, firmware, software, virtualized hardware, emulated architecture, and/or a combination thereof as discussed above, is configured to manage the configuration and deployment of the VNF instances on the network appliance 106. To do so, the VNF manager 210 is configured to identify or otherwise retrieve (e.g., from a policy) the configuration information and operational parameters of each VNF instance to be created and configured. The configuration information and operational parameters may include any information necessary to configure the VNF, including required resources, network configuration information, and any other information usable to configure a VNF instance.

For example, the configuration information may include the amount of resources (e.g., compute, storage, etc.) to be allocated. Additionally, the operational parameters may include any network interface information, such as a number of connections per second, mean throughput, max throughput, etc. The VNF manager 210 may be configured to use any standard network management protocol, such as Simple Network Management Protocol (SNMP), Network Configuration Protocol (NETCONF), etc. In some embodiments, the configuration information and/or the operational parameters may be stored in the platform configuration data 204.

The telemetry monitor 212, which may be embodied as hardware, firmware, software, virtualized hardware, emulated architecture, and/or a combination thereof as discussed above, is configured to monitor and collect telemetry data of particular physical and/or virtual resources of the network appliance 106. To do so, the telemetry monitor 212 may be configured to perform a discovery operation to identify and collect information/capabilities of those physical and/or virtual resources (i.e., platform resources) to be monitored. For example, the telemetry monitor 212 may be configured to leverage a resource management enabled platform, such as the Intel® Resource Director Technology (RDT) set of technologies (e.g., Cache Allocation Technology (CAT), Cache Monitoring Technology (CMT), Code and Data Prioritization (CDP), Memory Bandwidth Management (MBM), etc.) to monitor and collect the resource and telemetry data. In an illustrative example, the telemetry monitor 212 may be configured to collect platform resource telemetry data (e.g., thermal readings, NIC queue fill levels, processor core utilization, accelerator utilization, memory utilization, etc.), software telemetry data (e.g., port/flow statistics, poll success rate, etc.), network traffic telemetry data (e.g., network traffic receive rates, a number of dropped network packets, etc.), etc. In some embodiments, the collected telemetry data may be stored in the telemetry data 202.

The virtual switch operation mode controller 214, which may be embodied as hardware, firmware, software, virtualized hardware, emulated architecture, and/or a combination thereof as discussed above, is configured to manage the operation mode of a virtual switch of the network appliance 106 (see, e.g., the virtual switch 420 of FIG. 4). To do so, the illustrative virtual switch operation mode controller 214 includes a demand analyzer 216 and a resource selector 218. The demand analyzer 216 is configured to analyze the captured telemetry metrics, such as the monitored telemetry data described herein as being collected by the telemetry monitor 212, to determine which operation mode should be employed by the virtual switch while trying to keep the network appliance 106 in a cloud-ready and lower power-consuming state. Accordingly, the resource selector 218, which is configured to enable/disable certain resources depending on the operation made, can do so based on the operation mode as determined by the demand analyzer 216. In some embodiments, the operation mode and any applicable resource configuration information may be stored in the operation mode data 206.

In an illustrative example, the virtual switch operation mode controller 214, or more particularly the demand analyzer 216, analyzes the collected telemetry metrics to determine a present load on the network appliance 106. Accordingly, based on the determined load, the demand analyzer 216 is configured to set an operation mode of the virtual switch to one of a cloud ready mode (e.g., software accelerated), a virtual appliance mode (e.g., hardware and software accelerated wherein network traffic is distributed internally), or a legacy fallback mode (e.g., an overload or fixed function mode wherein the virtual switch is not operational and the network appliance reverts to fixed function legacy hardware operation). As such, the virtual switch operation mode controller 214, or more particularly the resource selector 218, can select whether to use on-board accelerations to cater to the present load, while trying to keep the system in a cloud-ready and less power-consuming state.

In other words, using real-time telemetry data, the resource selector 218 is configured to determine the appropriate resources to use for the determined virtual switch operation mode and trigger the resource transitions (e.g., enabled/disabled resources) between the various virtual switch operation modes. In the cloud ready mode, the fewer hardware accelerations used by the virtual switch can keep the system in a more “cloud ready” state, as the virtual switch is agnostic of the underlying hardware. Furthermore, reducing accelerator power consumption in cloud-ready mode has the side benefit of allowing more processor core capacity to be freed up to applications, potentially further improving the performance/watt of the network appliance 106. In the virtual appliance mode, should any specific hardware accelerations be used, it should be appreciated that the network appliance 106 is still trending toward being operated as a “virtual appliance” (e.g., as opposed to a traditional fixed appliance).

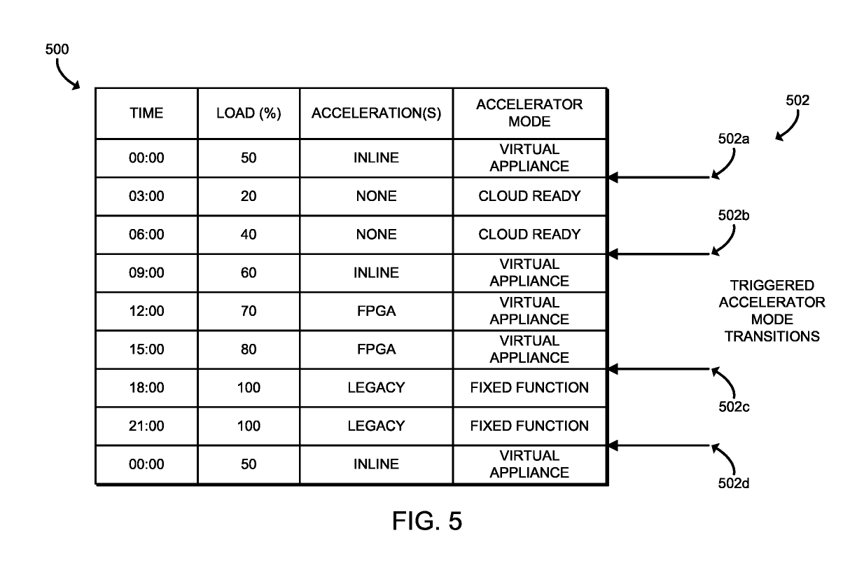

Should the determined present load exceed what the NFV infrastructure is capable of handling, even with the various accelerations enabled, a fallback option to legacy infrastructure can be triggered (i.e., the legacy fallback mode). It should be appreciated that, if the legacy fallback mode is triggered, the model is no longer considered to be an NFV mode, but rather a traditional fixed appliance. Depending on the embodiment, the transition to legacy fallback mode may be made under the additional guidance of a central infrastructure controller or orchestrator, due to the substantial change in operating infrastructure this transition could cause. While the various virtual switch operation modes are described above as being in one of three distinct modes (e.g., cloud ready mode, a virtual appliance mode, and a legacy fallback mode), it should be appreciated that additional and/or alternative modes may be employed in alternative embodiments. For example, in some embodiments, the virtual appliance mode may be comprised of multiple mode levels (e.g., depending on a corresponding capacity threshold). In such embodiments, each virtual appliance mode level may correspond to a different type or set of accelerators to be enabled for each virtual appliance mode level (see, e.g., the illustrative table 500 of FIG. 5 and related description in which the enabled accelerations in virtual appliance mode change based on the load percentage).

It should be appreciated that, in some embodiments, the virtual switch operation mode controller 214 may be configured to switch between the virtual switch operation modes and/or identify which accelerators to enable/disable based on one or more terms/conditions of a service level agreement (SLA). Accordingly, in such embodiments, the resource selector 218 is configured to determine the appropriate resources to use for the determined virtual switch operation mode based on the SLA and the real-time telemetry data. For example, the SLA may specify that one or more terms/conditions for which more than one resource configuration can accommodate. Under such conditions, the resource selector 218 may be configured to determine the resources based on the virtual switch operation mode specified by the virtual switch operation mode controller 214 and one or more other anticipated outcomes of each of the possible resources of the more than one resource configuration, such as a power usage, a resource utilization usage, etc. Further, in some embodiments, the resource selector 218 may apply a weighted value to the resources presently on, but not assigned/utilized, relative to those resources not presently powered on, and the costs associated therewith.

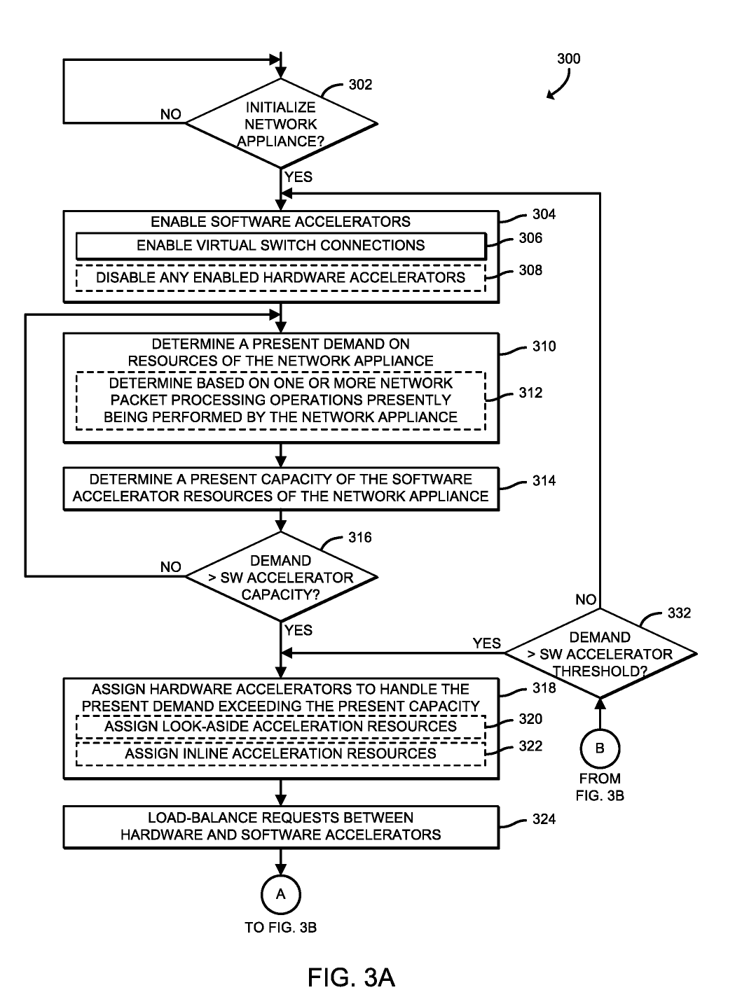

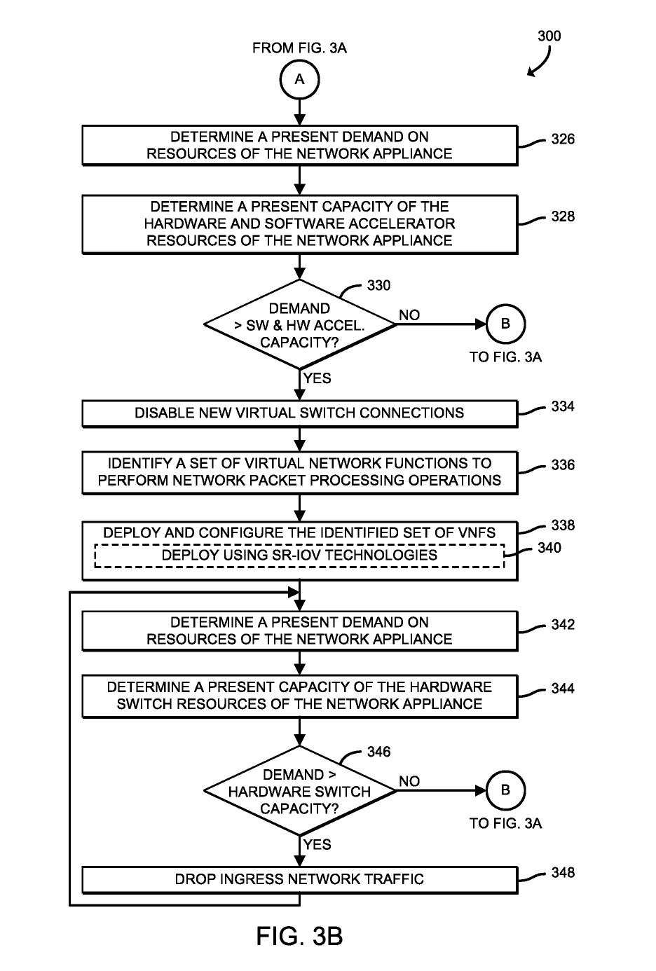

Referring now to FIGS. 3A and 3B, a method 300 for dynamically selecting resources for virtual switching is shown, which may be executed by a network appliance (e.g., the network appliance 106 of FIGS. 1 and 2), or more particularly by the virtual switch operation mode controller 214 of FIG. 2. It should be appreciated that the method 300 may be performed upon having detected a system load change, anticipating a system load change, or some other system load affecting activity either having been detected or expected to occur. The method 300 begins in block 302, in which the virtual switch operation mode controller 214 determines whether the network appliance 106 is being initialized. If so, method 300 advances to block 304, in which the virtual switch operation mode controller 214 enables one or more software accelerators (via, e.g., the software accelerator libraries 416 of FIG. 4). In other words, the virtual switch operation mode controller 214 initializes the virtual switch operation mode into cloud ready mode. Additionally, in block 306, the virtual switch operation mode controller 214 enables one or more connections associated with the virtual switch. In some embodiments, for example during subsequent iterations of the method 300 in which the virtual switch operation mode is being reverted back to cloud ready mode, the virtual switch operation mode controller 214 may disable any enabled hardware accelerators in block 308.

In block 310, the virtual switch operation mode controller 214 determines a present demand on resources of the network appliance 106, also referred to herein as a “present load”. To do so, in block 312, in some embodiments, the virtual switch operation mode controller 214 may determine the present load based on one or more network packet processing operations presently being performed by the network appliance, or more particularly by a VNF instance executing on the network appliance. In block 314, the virtual switch operation mode controller 214 determines a present capacity of the software accelerator resources of the network appliance. In some embodiments, the present capacity may be determined dynamically as a percentage of software accelerator resources available to handle the present load demanded of the software accelerator resources.

For example, the present capacity of the software accelerator resources may be configured to manage a demand up to a particular load threshold (e.g., a virtual appliance load threshold at 50% of load capacity). It should be appreciated that while the present capacity has been illustratively described herein as being particularly related to the present capacity of the software accelerator resources, the present capacity may include additional and/or alternative inputs. For example, in other embodiments, the present capacity may be determined by or otherwise influenced by an amount of network traffic being processed, the type/workloads associated with the network traffic being received, an amount of processing being performed on the received network traffic, etc. Furthermore, in such embodiments, one or more types of inputs may have different weighted values associated therewith. Accordingly, it should be further appreciated that, in such embodiments, the threshold may be predicated upon the type of inputs used to determine the present capacity. Additionally, in some embodiments, more than one capacity level may be compared against more than one corresponding capacity level to determine the virtual switch operation mode.

In block 316, the virtual switch operation mode controller 214 determines whether the demand exceeds (i.e., is greater than) the present capacity (e.g., of the software accelerator resources). If not, the method 300 reverts back to block 310 to again determine an updated present demand/load on resources of the network appliance 106; otherwise, the method 300 advances to block 318. In block 318, the virtual switch operation mode controller 214 assigns one or more hardware accelerators to handle the present demand exceeding the present capacity. In other words, the virtual switch operation mode controller 214 transitions the virtual switch operation mode from cloud ready mode to virtual appliance mode. To do so, in block 320, the virtual switch operation mode controller 214 may assign one or more look-aside acceleration resources (see, e.g., the lookaside accelerators 418 of FIG. 4). Additionally or alternatively, in block 322, the virtual switch operation mode controller 214 may assign one or more inline acceleration resources (see, e.g., the inline acceleration resources 410 of FIG. 4). In block 324, the virtual switch operation mode controller 214 load-balances received requests between the active (i.e., enabled) hardware and software accelerators.

In block 326, as shown in FIG. 3B, the virtual switch operation mode controller 214 determines an updated present demand on resources of the network appliance 106. In block 328, the virtual switch operation mode controller 214 determines a present capacity of the hardware and software accelerator resources of the network appliance 106. In some embodiments, the present capacity may be determined dynamically as a percentage of software and hardware accelerator resources available to handle the present load demanded of the enabled software and hardware accelerator resources. For example, the present capacity of the software and hardware accelerator resources may be configured to manage a demand up to a particular load threshold (e.g., a legacy fallback load threshold at 90% of load capacity).

In block 330, the virtual switch operation mode controller 214 determines whether the demand exceeds (i.e., is greater than) the present capacity of the software and hardware accelerator resources. If the demand does not exceed the present capacity of the software and hardware accelerators, the method 300 branches to block 332. In block 332, the virtual switch operation mode controller 214 determines whether the demand exceeds (i.e., is greater than) the present capacity of the software accelerator resources. In other words, the virtual switch operation mode controller 214 determines whether the virtual switch operation mode should be set to cloud ready mode (i.e., return to block 304) or remain in virtual appliance mode (i.e., return to block 318) and potentially adding/removing accelerators, as may be necessary.

If the virtual switch operation mode controller 214 determines that the demand does not exceed the present capacity of the software accelerators in block 332, the method 300 returns to block 304, in which the virtual switch operation mode controller 214 disables any enabled hardware accelerators. Otherwise, if the virtual switch operation mode controller 214 determines that the demand exceeds the present capacity of the software accelerators in block 332, the method 300 returns to block 318, in which the virtual switch operation mode controller 214 can assign additional or fewer (i.e., enable/disable) hardware accelerators, as necessary, to handle the present demand.

Referring back to block 330, if the demand exceeds the present capacity of the software and hardware accelerators, the method 300 branches to block 334. In block 334, the virtual switch operation mode controller 214 disables any new virtual switch connections. In other words, the virtual switch operation mode controller 214 transitions the virtual switch operation mode into legacy fallback mode. In block 336, the virtual switch operation mode controller 214 identifies a set of VNF instances to perform network packet processing operations. In block 338, the virtual switch operation mode controller 214 deploys and configures the identified set of VNF instances. To do so, in block 340, the virtual switch operation mode controller 214 may deploy the VNF instances using single-root I/O virtualization (SR-IOV) technologies.

In block 342, the virtual switch operation mode controller 214 determines an updated present demand on hardware switch resources of the network appliance 106. In block 344, the virtual switch operation mode controller 214 determines a present capacity of the hardware switch resources of the network appliance 106. In block 346, the virtual switch operation mode controller 214 determines whether the determined present demand is greater than the determined present hardware switch capacity. If so, the method 300 advances to block 348, in which network traffic is dropped, as there are insufficient resources to process the received network traffic. Otherwise, if the virtual switch operation mode controller 214 determines the present demand on the hardware switch resources does not exceed the updated present demand on the hardware switch resources, then the method 300 branches to block 332. As described previously, depending on the determination made by the virtual switch operation mode controller 214 in block 332, the virtual switch operation mode may be changed to cloud ready mode or virtual appliance mode, or remain in legacy fallback mode, depending on the present demand relative to the resources associated with the respective virtual switch operation mode.

Referring now to FIG. 4, in use, the network appliance 106 establishes an environment 400 during operation. The illustrative environment 400 includes the virtual switch operation mode controller 214 of FIG. 2 communicatively coupled to one or more platform drivers 404, one or more NIC drivers 406, and a virtual switch 420. As illustratively shown, the platform driver(s) 404 are communicatively coupled to one or more performance monitoring agents 408 for collecting platform telemetry data. The NIC driver(s) 406 are illustratively coupled to the NIC 120 of FIG. 1. The illustrative NIC 120 includes one or more inline accelerators 410, which may include one or more inline hardware accelerators 410a and/or one or more FPGA accelerators 410b. The illustrative NIC 120 additionally includes one or more physical ports 412 for facilitating the ingress and egress of network traffic to/from the NIC 120 of the network appliance 106.

The illustrative virtual switch 420 is communicatively coupled to multiple VNF instances 402 and includes an accelerator selector 414. As described previously, each of the VNF instances 402 may be embodied as one or more VMs (not shown) configured to execute corresponding software or instructions to perform a virtualized task. The illustrative VNF instances 402 include a first VNF instance 402 designated as VNF (1) 402a, a second VNF instance 402 designated as VNF (2) 402b, and a third VNF instance 402 designated as VNF (N) 402c (e.g., in which the VNF (N) 402c represents the “Nth” VNF instance 402, and wherein “N” is a positive integer). The accelerator selector 414 is configured to receive accelerator configuration instructions from the virtual switch operation mode controller 214, or more particularly from the resource selector 218 of the illustrative virtual switch operation mode controller 214 of FIG. 2, which are usable to determine which accelerator(s) to enable/disable (e.g., depending on the virtual switch operation mode in which the virtual switch 420 is to be operated).

As illustratively shown, the accelerator selector 414 is communicatively coupled to the NIC 120 (e.g., to control the inline accelerators 410 of the NIC 120), one or more lookaside accelerators 418 illustratively shown as one or more FPGA accelerators 418a and one or more hardware accelerators 418b, and one or more software accelerator libraries 416 to manage software acceleration. Accordingly, the accelerator selector 414 can enable/disable the respective accelerators based on the virtual switch operation mode (e.g., cloud ready mode, virtual appliance mode, or legacy fallback mode as determined by the virtual switch operation mode controller 214) that the virtual switch 420 is to be operated in.

Referring now to FIG. 5, an illustrative example of a table 500 is shown that illustrates a network appliance (e.g., the network appliance 106 of FIGS. 1, 2 and 4) having dynamically selected resources for virtual switching over an elapsed amount of twenty-four hours. As illustratively shown, the table 500 includes a time, a load percentage, the accelerations enabled, and a corresponding mode at the given time (e.g., based on the load percentage). For the purposes of the illustrative example, the load percentage is calculated as a simplified percentage value representing the aggregate of the various network traffic and platform key performance indicators for which the platform/software metrics as described previously have been collected. In the illustrative table 500, several virtual switch operation mode transitions 502 are illustratively shown. The first of the illustrative virtual switch operation mode transitions 502, designated as virtual switch operation mode transition 502a, shows a transition from virtual appliance mode to cloud ready mode, as the load has dropped below a virtual appliance load threshold (e.g., 50%) and, as such, no hardware accelerations (e.g., illustratively an inline accelerator) are required.

The second of the illustrative virtual switch operation mode transitions 502, designated as virtual switch operation mode transition 502b, shows a transition from cloud ready mode back to virtual appliance mode, as the load has again exceeded the virtual appliance load threshold (e.g., 50%) and, as such, a hardware acceleration (e.g., illustratively an inline accelerator) is required. As illustratively shown, while a transition has not occurred between the 09:00 and 12:00 time snapshots, the load percentage has increased (e.g., to 70%), which has resulted in additional and/alternative hardware accelerators being employed (e.g., illustratively an FPGA). Accordingly, it should be appreciated that mode-internal thresholds may be used in some embodiments to determine whether a portion of or all of the available accelerators are used (i.e., enabled) based on the load percentage.

The third of the illustrative virtual switch operation mode transitions 502, designated as virtual switch operation mode transition 502c, shows a transition from virtual appliance mode to legacy fallback mode, or fixed function mode, as the load has exceeded a fixed function load threshold (e.g., 90%) and, as such, a fallback to the fixed function legacy hardware operations are required. The fourth and last of the illustrative virtual switch operation mode transitions 502, designated as virtual switch operation mode transition 502d, shows a transition from legacy fallback mode to virtual appliance mode, as the load has again dropped below the fixed function load threshold (e.g., 90%), but remains above the virtual appliance load threshold (e.g., 50%) and, as such, software and hardware accelerations (e.g., illustratively an inline accelerator) are required. It should be appreciated that the load thresholds may be predetermined static load capacity thresholds, which may be assigned by an operator of the network in which the network appliance 106 has been deployed, in some embodiments.

### EXAMPLES

Illustrative examples of the technologies disclosed herein are provided below. An embodiment of the technologies may include any one or more, and any combination of, the examples described below.

Example 1 includes a network appliance for dynamically selecting resources for virtual switching, the network appliance comprising virtual switch operation mode circuitry to identify a present demand on resources of the network appliance, wherein the present demand indicates a demand on processing resources of the network appliance to process data associated with received network packets; determine a present capacity of one or more acceleration resources of the network appliance; determine a virtual switch operation mode based on the present demand and the present capacity of the acceleration resources, wherein the virtual switch operation mode indicates which of the acceleration resources are to be enabled; configure a virtual switch of the network appliance to operate as a function of the determined virtual switch operation mode; and assign acceleration resources of the network appliance as a function of the determined virtual switch operation mode.

Example 2 includes the subject matter of Example 1, and wherein to identify the present demand on resources of the network appliance comprises to identify a present demand on the acceleration resources of the network appliance.

Example 3 includes the subject matter of any of Examples 1 and 2, and wherein to assign the acceleration resources of the network appliance comprises to enable at least a portion of the acceleration resources or disable at least a portion of the acceleration resources.

Example 4 includes the subject matter of any of Examples 1-3, and wherein the acceleration resources include at one or more hardware accelerators, and wherein the one or more hardware accelerators include at least one of an inline hardware accelerator and a lookaside hardware accelerator.

Example 5 includes the subject matter of any of Examples 1-4, and wherein to determine the virtual switch operation mode comprises to determine whether the virtual switch is to operate in one of a cloud ready mode, a virtual appliance mode, or a legacy fallback mode.

Example 6 includes the subject matter of any of Examples 1-5, and wherein to determine the virtual switch operation mode further comprises to determine the virtual switch operation mode as a function of a first predetermined threshold based the cloud ready mode, a second predetermined threshold based the virtual appliance mode, and a third predetermined threshold based the legacy fallback mode.

Example 7 includes the subject matter of any of Examples 1-6, and wherein to assign the acceleration resources of the network appliance comprises to assign, subsequent to having configured the virtual switch to operate in a cloud ready mode, one or more software accelerators of the network appliance.

Example 8 includes the subject matter of any of Examples 1-7, and wherein to determine the present capacity of the acceleration resources of the network appliance comprises to determine a capacity of the assigned one or more software accelerators.

Example 9 includes the subject matter of any of Examples 1-8, and wherein to assign the acceleration resources of the network appliance comprises to assign, subsequent to having configured the virtual switch to operate in a virtual appliance mode, one or more software accelerators and one or more hardware accelerators.

Example 10 includes the subject matter of any of Examples 1-9, and wherein to determine the present capacity of the acceleration resources of the network appliance comprises to determine a capacity of the assigned one or more software accelerators and a capacity of the assigned one or more hardware accelerators.

Example 11 includes the subject matter of any of Examples 1-10, and wherein to assign the acceleration resources of the network appliance comprises to (i) disable any previously enabled software accelerators and (ii) disable any previously enabled hardware accelerators subsequent to having configured the virtual switch to operate in a legacy fallback mode.

Example 12 includes the subject matter of any of Examples 1-11, and wherein to configure the virtual switch to operate as a function of the determined virtual switch operation mode comprises to (i) enable one or more connections of the virtual switch in either one of a cloud ready mode or a virtual appliance mode, or (ii) disable the one or more connections of the virtual switch in a legacy fallback mode.

Example 13 includes one or more machine-readable storage media comprising a plurality of instructions stored thereon that, in response to being executed, cause a network appliance to identify a present demand on resources of the network appliance, wherein the present demand indicates a demand on processing resources of the network appliance to process data associated with received network packets; determine a present capacity of one or more acceleration resources of the network appliance; determine a virtual switch operation mode based on the present demand and the present capacity of the acceleration resources, wherein the virtual switch operation mode indicates which of the acceleration resources are to be enabled; configure a virtual switch of the network appliance to operate as a function of the determined virtual switch operation mode; and assign acceleration resources of the network appliance as a function of the determined virtual switch operation mode.

Example 14 includes the subject matter of Example 13, and wherein to identify the present demand on resources of the network appliance comprises to identify a present demand on the acceleration resources of the network appliance.

Example 15 includes the subject matter of any of Examples 13 and 14, and wherein to assign the acceleration resources of the network appliance comprises to enable at least a portion of the acceleration resources or disable at least a portion of the acceleration resources.

Example 16 includes the subject matter of any of Examples 13-15, and wherein the acceleration resources include at one or more hardware accelerators, and wherein the one or more hardware accelerators include at least one of an inline hardware accelerator and a lookaside hardware accelerator.

Example 17 includes the subject matter of any of Examples 13-16, and wherein to determine the virtual switch operation mode comprises to determine whether the virtual switch is to operate in one of a cloud ready mode, a virtual appliance mode, or a legacy fallback mode.

Example 18 includes the subject matter of any of Examples 13-17, and wherein to assign the acceleration resources of the network appliance comprises to assign, subsequent to having configured the virtual switch to operate in a cloud ready mode, one or more software accelerators of the network appliance.

Example 19 includes the subject matter of any of Examples 13-18, and wherein to determine the present capacity of the acceleration resources of the network appliance comprises to determine a capacity of the assigned one or more software accelerators.

Example 20 includes the subject matter of any of Examples 13-19, and wherein to assign the acceleration resources of the network appliance comprises to assign, subsequent to having configured the virtual switch to operate in a virtual appliance mode, one or more software accelerators and one or more hardware accelerators.

Example 21 includes the subject matter of any of Examples 13-20, and wherein to determine the present capacity of the acceleration resources of the network appliance comprises to determine a capacity of the assigned one or more software accelerators and a capacity of the assigned one or more hardware accelerators.

Example 22 includes the subject matter of any of Examples 13-21, and wherein to assign the acceleration resources of the network appliance comprises to (i) disable any previously enabled software accelerators and (ii) disable any previously enabled hardware accelerators subsequent to having configured the virtual switch to operate in a legacy fallback mode.

Example 23 includes the subject matter of any of Examples 13-22, and wherein to configure the virtual switch to operate as a function of the determined virtual switch operation mode comprises to (i) enable one or more connections of the virtual switch in either one of a cloud ready mode or a virtual appliance mode, or (ii) disable the one or more connections of the virtual switch in a legacy fallback mode.

Example 24 includes a network appliance for dynamically selecting resources for virtual switching, the network appliance comprising circuitry to enable and disable each of a plurality of acceleration resources of the network appliance based on one or more requirements of a service level agreement (SLA) and an associated power value of each of the plurality of acceleration resources, wherein the associated power value comprises an amount of power expected to be used in performance of one or more operations to be performed by an acceleration resource of the plurality of acceleration resources.

Example 25 includes the subject matter of Example 24, and wherein to enable and disable each of the plurality of acceleration resources comprises to identify a present demand on resources of the network appliance; determine a present capacity of each of the plurality of acceleration resources; determine which of the acceleration resources are to be enabled based on the present demand and the present capacity; and configure a virtual switch of the network appliance to operate based on which of the acceleration resources are determined to be enabled.

1. A network appliance for dynamically selecting resources for virtual switching, the network appliance comprising:
virtual switch operation mode circuitry to:
identify a present demand on resources of the network appliance, wherein the present demand indicates a demand on processing resources of the network appliance to process data associated with received network packets;
determine a present capacity of one or more acceleration resources of the network appliance;
determine a virtual switch operation mode based on the present demand and the present capacity of the acceleration resources, wherein the virtual switch operation mode indicates which of the acceleration resources are to be enabled;
configure a virtual switch of the network appliance to operate as a function of the determined virtual switch operation mode; and
assign acceleration resources of the network appliance as a function of the determined virtual switch operation mode.

2. The network appliance of claim 1, wherein to identify the present demand on resources of the network appliance comprises to identify a present demand on the acceleration resources of the network appliance.

3. The network appliance of claim 1, wherein to assign the acceleration resources of the network appliance comprises to enable at least a portion of the acceleration resources or disable at least a portion of the acceleration resources.

4. The network appliance of claim 1, wherein the acceleration resources include at one or more hardware accelerators, and wherein the one or more hardware accelerators include at least one of an inline hardware accelerator and a lookaside hardware accelerator.

5. The network appliance of claim 1, wherein to determine the virtual switch operation mode comprises to determine whether the virtual switch is to operate in one of a cloud ready mode, a virtual appliance mode, or a legacy fallback mode.

6. The network appliance of claim 5, wherein to determine the virtual switch operation mode further comprises to determine the virtual switch operation mode as a function of a first predetermined threshold based the cloud ready mode, a second predetermined threshold based the virtual appliance mode, and a third predetermined threshold based the legacy fallback mode.

7. The network appliance of claim 1, wherein to assign the acceleration resources of the network appliance comprises to assign, subsequent to having configured the virtual switch to operate in a cloud ready mode, one or more software accelerators of the network appliance.

8. The network appliance of claim 7, wherein to determine the present capacity of the acceleration resources of the network appliance comprises to determine a capacity of the assigned one or more software accelerators.

9. The network appliance of claim 1, wherein to assign the acceleration resources of the network appliance comprises to assign, subsequent to having configured the virtual switch to operate in a virtual appliance mode, one or more software accelerators and one or more hardware accelerators.

10. The network appliance of claim 9, wherein to determine the present capacity of the acceleration resources of the network appliance comprises to determine a capacity of the assigned one or more software accelerators and a capacity of the assigned one or more hardware accelerators.

11. The network appliance of claim 1, wherein to assign the acceleration resources of the network appliance comprises to (i) disable any previously enabled software accelerators and (ii) disable any previously enabled hardware accelerators subsequent to having configured the virtual switch to operate in a legacy fallback mode.

12. The network appliance of claim 1, wherein to configure the virtual switch to operate as a function of the determined virtual switch operation mode comprises to (i) enable one or more connections of the virtual switch in either one of a cloud ready mode or a virtual appliance mode, or (ii) disable the one or more connections of the virtual switch in a legacy fallback mode.

13. One or more machine-readable storage media comprising a plurality of instructions stored thereon that, in response to being executed, cause a network appliance to:
identify a present demand on resources of the network appliance, wherein the present demand indicates a demand on processing resources of the network appliance to process data associated with received network packets;
determine a present capacity of one or more acceleration resources of the network appliance;
determine a virtual switch operation mode based on the present demand and the present capacity of the acceleration resources, wherein the virtual switch operation mode indicates which of the acceleration resources are to be enabled;
configure a virtual switch of the network appliance to operate as a function of the determined virtual switch operation mode; and
assign acceleration resources of the network appliance as a function of the determined virtual switch operation mode.

14. The one or more machine-readable storage media of claim 13, wherein to identify the present demand on resources of the network appliance comprises to identify a present demand on the acceleration resources of the network appliance.

15. The one or more machine-readable storage media of claim 13, wherein to assign the acceleration resources of the network appliance comprises to enable at least a portion of the acceleration resources or disable at least a portion of the acceleration resources.

16. The one or more machine-readable storage media of claim 13, wherein the acceleration resources include at one or more hardware accelerators, and wherein the one or more hardware accelerators include at least one of an inline hardware accelerator and a lookaside hardware accelerator.

17. The one or more machine-readable storage media of claim 13, wherein to determine the virtual switch operation mode comprises to determine whether the virtual switch is to operate in one of a cloud ready mode, a virtual appliance mode, or a legacy fallback mode.

18. The one or more machine-readable storage media of claim 13, wherein to assign the acceleration resources of the network appliance comprises to assign, subsequent to having configured the virtual switch to operate in a cloud ready mode, one or more software accelerators of the network appliance.

19. The one or more machine-readable storage media of claim 18, wherein to determine the present capacity of the acceleration resources of the network appliance comprises to determine a capacity of the assigned one or more software accelerators.

20. The one or more machine-readable storage media of claim 13, wherein to assign the acceleration resources of the network appliance comprises to assign, subsequent to having configured the virtual switch to operate in a virtual appliance mode, one or more software accelerators and one or more hardware accelerators.

21. The one or more machine-readable storage media of claim 20, wherein to determine the present capacity of the acceleration resources of the network appliance comprises to determine a capacity of the assigned one or more software accelerators and a capacity of the assigned one or more hardware accelerators.

22. The one or more machine-readable storage media of claim 13, wherein to assign the acceleration resources of the network appliance comprises to (i) disable any previously enabled software accelerators and (ii) disable any previously enabled hardware accelerators subsequent to having configured the virtual switch to operate in a legacy fallback mode.

23. The one or more machine-readable storage media of claim 13, wherein to configure the virtual switch to operate as a function of the determined virtual switch operation mode comprises to (i) enable one or more connections of the virtual switch in either one of a cloud ready mode or a virtual appliance mode, or (ii) disable the one or more connections of the virtual switch in a legacy fallback mode.

24. A network appliance for dynamically selecting resources for virtual switching, the network appliance comprising:
circuitry to enable and disable each of a plurality of acceleration resources of the network appliance based on one or more requirements of a service level agreement (SLA) and an associated power value of each of the plurality of acceleration resources, wherein the associated power value comprises an amount of power expected to be used in performance of one or more operations to be performed by an acceleration resource of the plurality of acceleration resources.

25. The network appliance of claim 24, wherein to enable and disable each of the plurality of acceleration resources comprises to:
identify a present demand on resources of the network appliance;
determine a present capacity of each of the plurality of acceleration resources;
determine which of the acceleration resources are to be enabled based on the present demand and the present capacity; and
configure a virtual switch of the network appliance to operate based on which of the acceleration resources are determined to be enabled.
